(19) United States
(12) Patent Application Publication
(10) Pub. No.: US 2012/0252948 A1
(43) Pub. Date: Oct. 4, 2012

(54) QUICK-DRYING AND COATING-FREE INKJET INK COMPOSITION

(75) Inventors: Ke-Yung King, Hsinchu (TW); Hsueh-Chun Wu, Hsinchu (TW); Yi-Ching Lu, Hsinchu (TW)

(73) Assignee: JETBEST Corporation, Hsinchu (TW)

(21) Appl. No.: 13/206,635

(22) Filed: Aug. 10, 2011

(30) Foreign Application Priority Data
Mar. 31, 2011 (TW) 100111250

(51) Int. Cl. C08K 5/11

(52) U.S. Cl. 524/314

(57) ABSTRACT

A quick-drying and coating-free inkjet ink composition is provided, including a solvent, a colorant, a resin, a plasticizer, and a surfactant. The solvent is selected from the group consisting of aliphatic alcohols, alcohol ketones, ethylene glycol ethers, and propylene glycol ethers, and all have more than two carbon atoms in a molecule. The colorant is dissolved or dispersed in the solvent, and the amount of the colorant is 0.1 to 20% by weight of the total weight of the composition. The resin is used to adjust the viscosity of the inkjet ink composition, and the weight ratio of the resin to the colorant is 0.5:1 to 5:1. The plasticizer is used to increase redissolution of the resin, and the weight ratio of the plasticizer to the resin is 0.01:1 to 5:1. The amount of the surfactant is 0.01 to 2.0% by weight of the total weight of the composition.

### BACKGROUND OF THE INVENTION

1. Field of the Invention

The present invention relates generally to an inkjet ink composition, and more particularly relates to a quick-drying and coating-free inkjet ink composition, which can be directly used in the water-based inkjet printer, and can be printed onto a variety of special non-porous materials such as glass, acrylic, PET, and aluminum substrates. The inkjet ink composition of the present invention has high resolution, good adhesion characteristics.

2. The Prior Arts

The inkjet inks can be broadly divided into three categories comprising water-based inks, solvent-based inks, and UV curable inks, of which the water-based ink can only be printed on the material with a water absorption coating on the surface thereof, and furthermore the water-based ink mostly uses dye as a colorant, and has the disadvantages of poor water resistance, poor light resistance, and high cost of material, and therefore the water-based ink has been substantially replaced by the solvent-based ink. The solvent-based ink is based on organic solvent, and in the early stage of development, the solvent used includes the aromatic solvents such as toluene and xylene, and the toxic solvent such as cyclohexanone, isophorone, and methyl isobutyl ketone solvents with a pungent odor. With environmental awareness increasing, the solvent-based inks have been replaced by ECO environment-friendly inks. The environment-friendly inks use diethylene glycol ether as the main solvent. Compared with traditional solvent-based inks using ketones which can corrode the polyvinyl chloride (PVC) substrates, the sharpness and drying speed of inkjet printing are reduced inevitably. Moreover, the ECO inks can only be applied onto the PVC substrates. It is ironic that the inks are environment friendly, but the inkjet printing substrates are not environment friendly. An ink-absorbing coating is necessary when the ink is printed on special materials, such as PET, PP, PC, and PS boards etc, which limits the applications of printing. For the sake of pursuing the diversity of printing, an UV curable ink is thus developed.

The UV curable ink is cured by the following steps: the ink is exposed to the ultraviolet light immediately after being ejected through the nozzle, and then the photoinitiators added in the ink absorb the ultraviolet light, and split apart into free radicals, which attack the acrylate group C═C double bond and initiate polymerization to form the polymer film. Consequently, the UV curable inks can be printed on a variety of materials, have good scratch resistance and weather resistance. Because of the reduced generation of volatile organic compound (VOC) for the usage of UV curable inks, the UV curable inks boom in the United States and Europe.

However, the UV curable ink has the following shortcoming. Firstly, the cost of the UV curable ink and the UV-curable inkjet printer are high. The price of an UV-curable inkjet printer is at least one to two hundred thousand dollars, and the UV curable ink, which mainly consists of monomers, is expensive. Thus, the high cost for using the UV curable inks is not desired for competition in the market. Secondly, the UV curable ink can be applied to most of materials, but there are still many limitations in the application of the UV curable ink. The major problem of an UV curable ink is its relatively low resolution because an UV curable Ink printer adopts 35-42 pl industrial print heads, which reduce ink viscosity through heating. Due to lower requirements for advertisement applications, it is acceptable that ink dots are vaguer. However, the print quality cannot meet customer's requirements when the UV curable ink is applied onto a specific and high-price substrate. Thirdly, because the thickness of cured ink film is too large, the printing resolution of the UV-curable print head is relatively low, and the ductility is poor after curing, the UV curable ink cannot be applied to the popular 3C industries including mobile phone panel and notebook shell. An In-Mold-Decoration (IMD) technology is developed to overcome the above defects. The IMD technology incorporates printing and plastic injection molding to make the products more colorful. Because the printing side is positioned in the inside of the plastic film, the patterns are well protected, and thus scratch resistance and wear resistance of the products are greatly enhanced. Therefore, the IMD technology is particularly applied to the 3C products.

The ketones, esters, and glycol ethers as solvent are generally used in the solvent-based inks and the environment-friendly inks. In order to prevent the problem of the clogging of the nozzles to happen due to the high drying rate of the ink, the solvents having the boiling point higher than 150° C. to 180° C. at atmospheric pressure are usually used, and even the solvents having the boiling point up to 240° C. are used as the major component of environment-friendly inks. Due to the low evaporating rate of the solvents, the environment-friendly ink can only be applied onto the PVC substrate or ink-absorbing coating material. In addition, the ink container, and the material and the plastic parts of the inkjet printer must be made of corrosion-resistant and more expensive materials such as PE and PP, instead of cheaper materials such as ABS and PS which are commonly used in the water-based printer. Because of using the solvent of high boiling point and low vapor pressure, the printer for the solvent-based inks must be equipped with the expensive heating devices at the front, middle, and back stages, and thereby the price of the solvent-based inkjet printer is 4 to 5 times higher than that of water-based printer. Additionally, the solvent-based inks can only be applied to the roll-to-roll flexible inkjet materials, but not applied to the hard and thick materials, and thus the solvent-based inks need to be firstly printed on the PVC substrate, and then the PVC substrate with the printing is cut and pasted on the desired materials. In order to directly print ink onto a variety of substrates, a lot of money must be spent on purchasing the UV-curable inkjet printers, and furthermore the cost of the UV-curable ink is high, and however, the printing resolution of the UV-curable inkjet printers is poor.

### SUMMARY OF THE INVENTION

An objective of the present invention is to provide a quick-drying and coating-free inkjet ink composition, comprising a solvent, a colorant, a resin, a plasticizer, and a surfactant. The solvent is selected from the group consisting of aliphatic alcohols, alcohol ketones, ethylene glycol ethers, and propylene glycol ethers, wherein the aliphatic alcohols, alcohol ketones, ethylene glycol ethers, and propylene glycol ethers all have more than two carbon atoms in a molecule, and the solvent is present in an amount of more than 50% by weight of the total weight of the inkjet ink composition. The colorant is dissolved or dispersed in the solvent, and the colorant is present in an amount of 0.1 to 20% by weight of the total weight of the inkjet ink composition. The resin is used to adjust the viscosity of the inkjet ink composition, and the weight ratio of the resin to the colorant is 0.5:1 to 5:1. The plasticizer is used to increase redissolution of the resin, and the weight ratio of the plasticizer to the resin is 0.01:1 to 5:1. The surfactant is used to reduce the surface tension of the inkjet ink composition, and the surfactant is present in an amount of 0.01 to 2.0% by weight of the total weight of the inkjet ink composition. Moreover, the viscosity of the inkjet ink composition at 25° C. is in the range of 3.0 to 15 cps, and the surface tension of the inkjet ink composition is in the range of 18 to 40 dyne/cm.

Accordingly, the quick-drying and coating-free inkjet ink composition of the present invention can be directly used in the water-based piezoelectric and thermal-bubble inkjet printers without extra devices, and thereby the production cost is reduced. The quick-drying and coating-free inkjet ink composition of the present invention can be printed onto a variety of specific materials, such as glass, acrylic, PET, PC, PS, aluminum substrates, or other non-porous substrates. Additionally, the inkjet ink composition of the present invention has the advantages of a broad range of applicability, non-pungent odor, high resolution, and good adhesion.

### DETAILED DESCRIPTION OF THE PREFERRED EMBODIMENT

The present invention will be apparent to those skilled in the art by reading the following detailed description of the preferred embodiments thereof.

The present invention provides a quick-drying and coating-free inkjet ink composition, comprising a solvent, a colorant, a resin, a plasticizer, and a surfactant. The solvent is selected from the group consisting of aliphatic alcohols, alcohol ketones, ethylene glycol ethers, and propylene glycol ethers, wherein the aliphatic alcohols, alcohol ketones, ethylene glycol ethers, and propylene glycol ethers all have more than two carbon atoms in a molecule, and the solvent is present in an amount of more than 50% by weight of the total weight of the inkjet ink composition. The colorant is dissolved or dispersed in the solvent, and the colorant is present in an amount of 0.1 to 20% by weight of the total weight of the inkjet ink composition. The resin is used to adjust the viscosity of the inkjet ink composition, and the weight ratio of the resin to the colorant is 0.5:1 to 5:1. The plasticizer is used to increase redissolution of the resin, and the weight ratio of the plasticizer to the resin is 0.01:1 to 5:1. The surfactant is used to reduce the surface tension of the inkjet ink composition, and the surfactant is present in an amount of 0.01 to 2.0% by weight of the total weight of the inkjet ink composition. Moreover, the viscosity of the inkjet ink composition at 25° C. is in the range of 3.0 to 15 cps, and the surface tension of the inkjet ink composition is in the range of 18 to 40 dyne/cm.

For the broad range of applicability and the needs of quality and cost of the inks, the present invention uses the solvents which have fast volatilization speed as the major component of the inkjet ink composition. The ink which passes through the nozzle can be ejected onto a variety of substrates because the inkjet ink composition has the fast volatile solvent and the adhesive resin. The boiling point of the solvent of the inkjet ink composition is in the range of 70° C. to 190° C., and the vapor pressure is more than 0.3 mmHg at 20° C.

In order to effectively reduce the surface tension and increase the spread of the ink on a variety of the substrates, a small amount of aliphatic alcohols are added to the solvent of the quick-drying and coating-free inkjet ink composition, wherein the aliphatic alcohols are selected from the group consisting of ethanol, n-propanol, isopropanol, n-butanol, isobutanol, tert-butanol, n-pentanol, isopentanol, 2-pentanol, 3-pentanol, tert-pentanol, hexanol, methylpentanol, and 2-ethylbutanol, and the aliphatic alcohols are present in an amount of 0.01 to 20% by weight of the total weight of the inkjet ink composition, which can increase the solubility and improve the drying rate of the inkjet ink composition.

In order to avoid high evaporation rate of the ink which will result in the nozzle clogging, a small amount of solvents of high boiling point and low vapor pressure are added to the solvent of the quick-drying and coating-free inkjet ink composition, and then the boiling point of the inkjet ink composition is adjusted to 120° C. to 190° C. Furthermore, the amount of solvent used to adjust the boiling point of the inkjet ink composition is 0.01% to 30% by weight of the total weight of the inkjet ink composition, and the vapor pressure of the solvent used to adjust the boiling point of the inkjet ink composition is more than 0.3 mmHg, and preferably 0.5 to 5 mmHg. The solvent used to adjust the boiling point of the inkjet ink composition is selected from the group consisting of diethylene glycol monomethyl ether, diethylene glycol monoethyl ether, diethylene glycol butyl ether, dipropylene glycol monomethyl ether, dipropylene glycol monobutyl ether, dipropylene glycol isobutyl ether, dipropylene glycol monopropyl ether, and alcohol ketones, such as 4-hydroxy-4-methyl-2-pentanone, 3-hydroxy-3-methyl-2-butanone, and 4-hydroxy-3-methyl-2-butanone.

In addition, when printed onto the substrate, a cloudy white pattern is printed out due to the fast evaporation of the solvent after absorbing heat, which causes the condensed water vapor formed on the surface of the pattern. The solvent of the quick-drying and coating-free inkjet ink composition of the present invention can include an appropriate amount of ethylene glycol ethers having the general formula of H(—OC₂H₄)ₙ—OR, wherein R is an alkyl group having 1 to 4 carbon atoms, and n is an integer from 1 to 2, and the ethylene glycol ethers are present in an amount of 0.01 to 20% by weight of the total weight of the inkjet ink composition. The ethylene glycol ethers are selected from the group consisting of ethylene glycol monomethyl ether, ethylene glycol monoethyl ether, or ethylene glycol monobutyl ether. In view of safety, ethylene glycol monobutyl ether is preferable.

The solvent of the quick-drying and coating-free inkjet ink composition of the present invention must be non-corrosive to the substrate such as ABS or PS substrate, and the solvent is preferably an organic solvent which has high evaporation rate. The solvent used in the present invention includes the propylene glycol ethers having the general formula of H(—OC₃H₆)ₙ—OR, wherein R is an alkyl group having 1 to 4 carbon atoms, and n is an integer from 1 to 2, and the propylene glycol ethers are present in an amount of 30 to 70% by weight of the total weight of the inkjet ink composition. The solvent used in the present invention preferably has the vapor pressure of at least 10 mmHg (at 20° C.), and the solvent is preferably selected from propylene glycol monomethyl ether, propylene glycol monopropyl ether, propylene glycol monobutyl ether, and propylene glycol monoisobutyl ether.

The colorant of the present quick-drying and coating-free inkjet ink composition can be white or colored inorganic pigments, organic pigments, or dyes. For example, the inorganic pigments and organic pigments are selected from titanium dioxide, anthraquinone, pyrimidine, diketone pyrrole, benzimidazole ketones, azo, phthalocyanine blue, hetero-(indole) ketone, (quinoline acridine) ketone, dioxins (hydrochloride), indanthrene, perylene, perylene ketones, sulfur indigo, quinone ketone, or metal complexes. The dyes are selected from metallic salts, azo, anthraquinone, kaempferol, indigo, carbon ions, quinone imine, xanthine, nitro, anthocyanin, (quinoline) morpholino, nitroso, benzoquinone, quinone, phthalocyanine blue, or metal phthalocyanine. The oil-soluble dyes are preferably selected when the dye ink is used. In view of chemical resistance and light resistance, the pigments are preferably used. These colorants can be used alone or in combination.

The resins added to the quick-drying and coating-free inkjet ink composition of the present invention are used to adjust the viscosity of the ink, and should meet the requirements of the specifications of the various print heads. The resins used can improve the adhesion, the scratch resistance, the abrasion resistance, the water resistance, the brightness and the weather resistance, and preferably are selected from the group consisting of polyamide resin, acrylic resin, styrene resin, phenol resin, keto-aldehyde resins, phenolic resin, polyvinyl butyral resin, and polyvinyl pyrrolidone resin, and the solubility of the resin in the solvent is at least 20 wt % and is preferably more than 40 wt %, and the molecular weight of the resin is in the range of 5,000 to 100,000 and is preferably 10,000 to 30,000, and the glass transition temperature (Tg) of the resin is more than 40° C. Depending on the substrate used, the different varieties of resins can be mixed to improve the adhesion and the strength of film.

The inkjet ink composition of the present invention is quick-drying, and thereby it is needed that the high evaporation rate of the solvent, and the good solubility of the resin to the alcohols. In order to avoid the permanent clog of the nozzle by the resin film formed on the nozzle due to the evaporation the ink, The plasticizer is selected from the group consisting of phthalate esters, alkyl phenol sulfonic acid esters, adipic acid ester, decanedioic acid esters, castor oils, phosphate esters, and citric acid esters. In order to improve the redissolution of the resin, the weight ratio of the plasticizer to the resin is 0.01:1 to 5:1, and preferably 0.1:1 to 3:1, more preferably 0.5:1 to 1:1. As the result, the inkjet ink composition of the present invention is in a soft state even when the high-volatile solvent is used in the inkjet ink composition, and the nozzle is under high pressure and high temperature conditions, and thereby the nozzle will not be clogged, and the resin contained in the ink can be hardened at room temperature after the ink is ejected onto the substrate.

In order to reduce the surface tension of the inkjet ink composition and endow the ink with excellent leveling effect, the surfactant used in the present invention is selected from the group consisting of organic silicon compound, and fluorocarbon compound, and the surfactant can be anion type, cation type, nonion type, or amphoteric ion type. The quick-drying and coating-free inkjet ink composition of the present invention can be applied onto a variety of substrates, and the surface tension of ink must be lower than that of substrate for achieving the excellent leveling effect. Therefore, the surface tension of the inkjet ink composition of the present invention is in the range of 18 to 40 dyne/cm, and preferably 20 to 30 dyne/cm. Because the solvents used in the present invention have the hydroxyl groups, the fluorocarbon surfactants can enhance the strength of the hydrogen bonds formed between the molecules, and the surface tension of the ink can be effectively reduced so that the excellent leveling effect can be achieved, and the bleeding and beading phenomenon will not appear, and the printing quality can be greatly improved.

The quick-drying and coating-free inkjet ink composition of the present invention can be used in the water-based and oil-based printers, and can be directly printed onto the substrate without the ink-absorbing coating layer or any other treatment. By adjusting the surface tension, the inkjet ink composition can be printed onto the specific substrate and get the excellent printing quality. The inkjet ink composition of the present invention is quick-drying, and does not damage the nozzle. The inkjet ink composition of the present invention can get the excellent printing quality on a variety of the substrates. In the manufacturing process, the weather resistance and heat resistance of the inkjet ink composition must also be considered. In view of the environmental protection, the restriction on the raw materials used must be taken into account in the present invention.

The quick-drying and coating-free inkjet ink composition of the present invention can expand the digital inkjet ink application to, such as IMD production, touch panel production, and e-books production, instead of restricting to the color advertisement. Furthermore, the inkjet ink composition of the present invention can simplify the manufacturing process, reduce the production cost, and meet the demand of industrial application with the development of the printers. The manufacturing process is easily controlled, and the yield is greatly improved, and thereby the digital inkjet ink can be brought to a brand new area and the great value can be created.

The addition amounts of the components in the quick-drying and coating-free inkjet ink composition of the present invention depend on the ink color and the nozzle specification. The inkjet ink composition of the present invention can be applied to the various brands of piezoelectric and thermal-bubble inkjet printers, and can be printed onto a variety of the substrates.

The following examples are given to illustrate the invention and some mode of carrying out the invention. The following examples are only the preferred embodiments for carrying out the present invention; however, it is not intended to restrict the invention to these particular examples. Any modifications that are in the spirit of the present invention are considered part of this invention.

### Preparation of the Pigment Dispersion

20 weight ratio of carbon black (Japan Mitsubishi Chemical, MA-100R) and 12 weight ratio of dispersant (Germany BYK company, BYK-2001) are added to 68 weight ratio of propylene glycol monomethyl ether followed by mixing for one hour at 500 rpm of rotational speed with a high-speed dispersion machine, and then 50% by volume of zirconia beads (2.0 mm) are added to the above mixture, and then the resultant mixture is pre-dispersed in a ball mill, and the coarse grinded pigment has the average particle diameter of less than 1 μM. Thereafter, the pigment dispersion is further dispersed in a nano-grinder. After the filtering step, the black pigment dispersion is obtained, and the black pigment in the black pigment dispersion has the average particle diameter of about 80 nm, and the black pigment dispersion has a viscosity of 10 cps.

20 weight ratio of C.I. Pigment Y150 (Germany Bayer company, Yellow E4GN) and 12 weight ratio of dispersant (Germany Lubrizol company, 576500) are added to 68 weight ratio of propylene glycol monomethyl ether followed by mixing for one hour at 500 rpm of rotational speed with a high-speed dispersion machine, and then 50% by volume of zirconia beads (2.0 mm) are added to the above mixture, and then the resultant mixture is pre-dispersed in a ball mill, and the coarse grinded pigment has the average particle diameter of less than 1 μm. Thereafter, the pigment dispersion is further dispersed in a nano-grinder. After the filtering step, the yellow pigment dispersion is obtained, and the yellow pigment in the yellow pigment dispersion has the average particle diameter of about 150 nm, and the yellow pigment dispersion has a viscosity of 20 cps.

20 weight ratio of C.I. Pigment R122 (Germany Seba company, Magenta Pink PT) and 12 weight ratio of dispersant (Japanese Kusumoto chemistry, DA-325) are added to 68 weight ratio of propylene glycol monomethyl ether followed by mixing for one hour at 500 rpm of rotational speed with a high-speed dispersion machine, and then 50% by volume of zirconia beads (2.0 mm) are added to the above mixture, and then the resultant mixture is pre-dispersed in a ball mill, and the coarse grinded pigment has the average particle diameter of less than Thereafter, the pigment dispersion is further dispersed in a nano-grinder. After the filtering step, the red pigment dispersion is obtained, and the red pigment in the red pigment dispersion has the average particle diameter of about 120 nm, and the red pigment dispersion has a viscosity of 15 cps.

20 weight ratio of C.I. Pigment Blue 15:3 (Germany Seba company, Blue GLO) and 12 weight ratio of dispersant (Germany BYK company, BYK-163) are added to 68 weight ratio of propylene glycol monomethyl ether followed by mixing for one hour at 500 rpm of rotational speed with a high-speed dispersion machine, and then 50% by volume of zirconia beads (2.0 mm) are added to the above mixture, and then the resultant mixture is pre-dispersed in a ball mill, and the coarse grinded pigment has the average particle diameter of less than 1 μm. Thereafter, the pigment dispersion is further dispersed in a nano-grinder. After the filtering step, the blue pigment dispersion is obtained, and the blue pigment in the blue pigment dispersion has the average particle diameter of about 120 nm, and the blue pigment dispersion has a viscosity of 10 cps.

The samples of the quick-drying and coating-free inkjet ink composition are shown in Table 1-1 and Table 1-2.

TABLE 1-1

| Raw material | Sample 1 | Sample 2 | Sample 3 | Sample 4 | Sample 5 | Sample 6 | Sample 7 |
|---|---|---|---|---|---|---|---|
| Black pigment dispersion | 20 | 20 | 20 | 20 | 20 | 20 | 20 |
| Yellow pigment dispersion | — | — | — | — | — | — | — |
| Magenta pigment dispersion | — | — | — | — | — | — | — |
| Cyan pigment dispersion | — | — | — | — | — | — | — |
| Isopropanol | — | — | — | — | — | — | — |
| 4-Hydroxy-4-methyl-2- | — | 20 | 30 | 30 | 20 | 20 | 20 |
| pentanone | | | | | | | |
| Ethylene glycol | — | — | — | — | — | — | — |
| monobutyl ether | | | | | | | |
| Propylene glycol | 63.9 | 43.9 | 37.9 | 37.9 | 37.9 | 37.9 | 37.9 |
| monomethyl ether | | | | | | | |
| Dipropylene glycol | — | — | — | — | 10 | 10 | 10 |
| monomethyl ether | | | | | | | |
| Polyvinyl butyral resin | 8 | 8 | 8 | 8 | 8 | — | 4 |
| (WACKER BL-18) | | | | | | | |
| Acrylic resin (Rohm and | — | — | — | — | — | 8 | 4 |
| Haas B-66) | | | | | | | |
| Decanedioic acid ester | 8 | 8 | 4 | 4 | 4 | 4 | 4 |
| (UPC DOS) | | | | | | | |
| Organic silicon surfactant | 0.1 | 0.1 | 0.1 | — | — | — | — |
| (Shin-Etsu KP-341) | | | | | | | |
| Fluorocarbon | — | — | — | 0.1 | 0.1 | 0.1 | 0.1 |
| surfactant (3M FC-4430) | | | | | | | |

TABLE 1-2

| Raw material | Sample 8 | Sample 9 | Sample 10 | Sample 11 | Sample 12 | Sample 13 |
|---|---|---|---|---|---|---|
| Black pigment dispersion | 20 | 20 | 20 | — | — | — |
| Yellow pigment dispersion | — | — | — | 25 | — | — |
| Magenta pigment dispersion | — | — | — | — | 30 | — |
| Cyan pigment dispersion | — | — | — | — | — | 20 |
| Isopropanol | — | 10 | 5 | 5 | 5 | 5 |
| 4-Hydroxy-4-methyl-2- | 20 | 20 | 20 | 20 | 20 | 20 |
| pentanone | | | | | | |
| Ethylene glycol | 10 | — | 5 | 5 | 5 | 5 |
| monobutyl ether | | | | | | |
| Propylene glycol | 32.9 | 27.9 | 27.9 | 22.9 | 17.9 | 27.9 |
| monomethyl ether | | | | | | |
| Dipropylene glycol | 5 | 10 | 10 | 10 | 10 | 10 |
| monomethyl ether | | | | | | |
| Polyvinyl butyral resin | 4 | 4 | 4 | 4 | 4 | 4 |
| (WACKER BL-18) | | | | | | |
| Acrylic resin (Rohm and | 4 | 4 | 4 | 4 | 4 | 4 |
| Haas B-66) | | | | | | |
| Decanedioic acid ester | 4 | 4 | 4 | 4 | 4 | 4 |
| (UPC DOS) | | | | | | |
| Organic silicon surfactant | — | — | — | — | — | — |
| (Shin-Etsu KP-341) | | | | | | |
| Fluorocarbon surfactant | 0.1 | 0.1 | 0.1 | 0.1 | 0.1 | 0.1 |
| (3M FC-4430) | | | | | | |

The evaluation tests for the quick-drying and coating-free inkjet ink composition of the present invention are shown in the followings:
1. the viscosity test of the inkjet ink composition: Brookfield DV-E type rotating viscometer is used, and the temperature is controlled at 25° C.;
2. the surface tension test of the inkjet ink composition: CBVP-A3 type surface tensiometer manufactured by Kyowa Interface Science Co., Ltd. is used;
3. the particle diameter test of the inkjet ink composition: LA-950 type particle diameter analyzer manufactured by HORIBA STEC Co., Ltd. is used, and the average particle diameter of the ink, D50 and D90 (nm) are determined;
4. the printing test of the inkjet ink composition: VS-300 type Inkjet Printer manufactured by Roland DG Corporation is used, and the printer is shut down for three days, and then the cleaning process is started, and then the nozzle test is carried out, and the ink is completely ejected from the nozzle, and no clogging and no ink oblique ejection occur;
   Evaluation A: the printer is shut down for more than 3 days, and then the cleaning process is started once or twice;
   Evaluation B: the printer is shut down for more than 3 days, and then the powerful cleaning process is started once;
   Evaluation C: the printer is shut down for more than 3 days, and then the powerful cleaning process is started more than once;
5. the printing pattern test of the inkjet ink composition: VS-300 type Inkjet Printer manufactured by Roland DG Corporation is used, and the inkjet ink composition is printed onto an acrylic substrate;
   Evaluation A: no ink bleeding phenomenon occurs, and a clear pattern is printed out;
   Evaluation B: a little bleeding phenomenon occurs in the heavy ink area, and an acceptable pattern is printed out;
   Evaluation C: serious bleeding phenomenon occurs, an unclear pattern is printed out;
6. the stability test of the inkjet ink composition: VS-300 type Inkjet Printer manufactured by Roland DG Corporation is used for continuous printing pattern;
   Evaluation A: during 12 hours of continuous printing test, the loss of nozzle or the misdirection of ink drops occurs for less than 5 times;
   Evaluation B: during 12 hours of continuous printing test, the loss of nozzle or the misdirection of ink drops occurs for 5 to 10 times;
   Evaluation C: during 12 hours of continuous printing test, the intermittent, the loss of nozzle or the misdirection of ink drops occurs for more than 10 times;
7. the adhesion test of the inkjet ink composition: a cross-cutting at 90 degrees is carried out on the surface of the printed pattern by using BYK A-5123 type knife to form the mesh grid (25 cells/100 cells) with the specific intervals, and then the pattern is peeled by using the test adhesive tape of 3M Scotch Cellophane Film Tape 610, and the peel result is observed:
   Evaluation A: no peeling of the pattern edge, the pattern remains intact;
   Evaluation B: partly peeling of the pattern edge, the pattern is acceptable;
   Evaluation C: seriously peeling of the pattern edge, the pattern is incomplete;
8. the gloss test of the inkjet ink composition: the gloss of the pattern printed on the acrylic substrate by using BYK AG-4442 gloss 60 of gloss meter is determined:
   Evaluation A: the increase of gloss test value is more than 5%;
   Evaluation B: the increase of gloss test value is less than 5%;
   Evaluation C: no change on the gloss test value or the gloss test value is decreased;
9. the high temperature stability test of the inkjet ink composition: the ink is filled into a sealed glass bottle, and the bottle is placed at 45° C. for eight weeks, and then the bottle is placed at room temperature for the test of the viscocity and the average particle diameter.
   Evaluation A: the changes of the viscocity and the average particle diameter measurement values of ink are less than 5%;
   Evaluation B: the changes of the viscocity and the average particle diameter measurement values of ink are less than 10%;
   Evaluation C: the changes of the viscocity and the average particle diameter measurement values of ink are more than 10%;
10. the low temperature stability test of the inkjet ink composition: the ink is filled into a sealed glass bottle, and the bottle is placed at −10° C. for eight weeks, and then the bottle is placed at room temperature for the test of the viscocity and the average particle diameter;
   Evaluation A: the changes of the viscocity and the average particle diameter measurement values of ink are less than 5%;
   Evaluation B: the changes of the viscocity and the average particle diameter measurement values of ink are less than 10%;
   Evaluation C: the changes of the viscocity and the average particle diameter measurement values of ink are more than 10%;
11. the drying rate test: the color pattern is printed onto the acrylic substrate at the room temperature, and after a period of time, a white paper is pressed onto the pattern, and the transfer printing on the white paper is observed:
   Evaluation A: within 3 minutes;
   Evaluation B: between 3-5 minutes;
   Evaluation C: above 5 minutes.

The test results of the quick-drying and coating-free inkjet ink composition of the present invention are shown in Table 2-1 and Table 2-2.

TABLE 2-1

| Test item | Sample 1 | Sample 2 | Sample 3 | Sample 4 | Sample 5 | Sample 6 | Sample 7 |
|---|---|---|---|---|---|---|---|
| Viscosity (cps, 25° C.) | 5.38 | 5.72 | 5.28 | 5.28 | 5.24 | 3.77 | 4.32 |
| Surface tension (dyne/cm) | 26.1 | 26.3 | 26.0 | 23.5 | 23.5 | 23.2 | 23.4 |
| Average particle diameter (nm) | 93.1 | 95.4 | 93.3 | 92.6 | 98.6 | 94.7 | 93.2 |
| D50 (nm) | 99 | 98 | 102 | 99 | 99 | 101 | 100 |
| D90 (nm) | 159 | 162 | 168 | 165 | 164 | 166 | 160 |
| Room temperature | C | B | A | A | A | A | A |
| nozzle test | | | | | | | |
| Printing pattern test | A | A | B | A | B | B | B |
| Room temperature | C | C | B | B | A | A | A |
| stability test | | | | | | | |
| Adhesion test | — | — | B | B | B | A | A |
| Gloss Test | — | — | C | C | C | B | B |
| High temperature | — | — | — | — | — | — | — |
| stability test | | | | | | | |
| Low temperature | — | — | — | — | — | — | — |
| stability test | | | | | | | |
| Drying speed test | B | B | A | A | B | B | B |

TABLE 2-2

| Test item | Sample 8 | Sample 9 | Sample 10 | Sample 11 | Sample 12 | Sample 13 |
|---|---|---|---|---|---|---|
| Viscosity (cps, 25° C.) | 4.39 | 4.16 | 4.45 | 4.64 | 5.03 | 4.96 |
| Surface tension (dyne/cm) | 23.5 | 22.5 | 22.5 | 22.6 | 22.3 | 22.7 |
| Average particle | 94.4 | 92.6 | 93.7 | 120.9 | 147.8 | 103.9 |
| diameter (nm) | | | | | | |
| D50 (nm) | 99 | 98 | 99 | 117 | 162 | 130 |
| D90 (nm) | 158 | 164 | 163 | 196 | 261 | 281 |
| Room temperature | B | B | A | B | A | A |
| nozzle test | | | | | | |
| Printing pattern test | B | A | A | A | A | A |
| Room temperature | B | B | A | A | A | A |
| stability test | | | | | | |
| Adhesion test | A | A | A | A | A | A |
| Gloss Test | A | B | A | A | B | A |
| High temperature | — | — | A | B | A | A |
| stability test | | | | | | |
| Low temperature | — | — | A | A | A | A |
| stability test | | | | | | |
| Drying speed test | A | A | A | A | A | A |

It is showed in Table 2-1 and Table 2-2 that the samples 10-12 of the quick-drying and coating-free inkjet ink composition are satisfactory, the samples 1-2 have the application problem due to the very fast evaporation rate of ink, the samples 3-5 can dramatically avoid the bleeding and beading phenomenon by using fluorocarbon surfactants, but the pattern exhibits extinction phenomenon and poor adhesion, the samples 6-7 can improve the adhesion by changing the resin, and the samples 8-9 can dramatically improve the pattern extinction phenomenon, and the surface tension of ink is reduced, and the sharpness and drying speed of the pattern are increased.

Although the present invention has been described with reference to the preferred samples thereof, it is apparent to those skilled in the art that a variety of modifications and changes may be made without departing from the scope of the present invention which is intended to be defined by the appended claims.

What is claimed is:

1. A quick-drying and coating-free inkjet ink composition, comprising:
a solvent selected from the group consisting of aliphatic alcohols, alcohol ketones, ethylene glycol ethers, and propylene glycol ethers which have more than two carbon atoms in a molecule, the solvent being present in an amount of more than 50% by weight of the total weight of the inkjet ink composition;
a colorant dissolved or dispersed in the solvent, the colorant being present in an amount of 0.1 to 20% by weight of the total weight of the inkjet ink composition;
a resin used to adjust viscosity of the inkjet ink composition, the weight ratio of the resin to the colorant being 0.5:1 to 5:1;
a plasticizer used to increase redissolution of the resin, the weight ratio of the plasticizer to the resin being 0.01:1 to 5:1; and
a surfactant used to reduce the surface tension of the inkjet ink composition, the surfactant being present in an amount of 0.01 to 2.0% by weight of the total weight of the inkjet ink composition;
wherein the viscosity of the inkjet ink composition at 25° C. is in the range of 3.0 to 15 cps, and the surface tension of the inkjet ink composition is in the range of 18 to 40 dyne/cm.

2. The quick-drying and coating-free inkjet ink composition as claimed in claim 1, wherein a boiling point of the solvent is in the range of 70° C. to 190° C., and the vapor pressure of the solvent is more than 0.3 mmHg at 20° C.

3. The quick-drying and coating-free inkjet ink composition as claimed in claim 1, wherein the aliphatic alcohols are selected from the group consisting of ethanol, n-propanol, isopropanol, n-butanol, isobutanol, tert-butanol, n-pentanol, isopentanol, 2-pentanol, 3-pentanol, tert-pentanol, hexanol, methylpentanol, and 2-ethylbutanol, and the aliphatic alcohols are present in an amount of 0.01 to 20% by weight of the total weight of the inkjet ink composition.

4. The quick-drying and coating-free inkjet ink composition as claimed in claim 1, wherein the alcohol ketones are selected from the group consisting of 4-hydroxy-4-methyl-2-pentanone, 3-hydroxy-3-methyl-2-butanone, and 4-hydroxy-3-methyl-2-butanone, and the alcohol ketones are present in an amount of 0.01 to 30% by weight of the total weight of the inkjet ink composition.

5. The quick-drying and coating-free inkjet ink composition as claimed in claim 1, wherein the ethylene glycol ethers have the general formula of H(—OC₂H₄)ₙ—OR, wherein R is an alkyl group having 1 to 4 carbon atoms, and n is an integer from 1 to 2, and the ethylene glycol ethers are present in an amount of 0.01 to 20% by weight of the total weight of the inkjet ink composition.

6. The quick-drying and coating-free inkjet ink composition as claimed in claim 1, wherein the propylene glycol ethers have the general formula of H(—OC₃H₆)ₙ—OR, wherein R is an alkyl group having 1 to 4 carbon atoms, and n is an integer from 1 to 2, and the propylene glycol ethers are present in an amount of 30 to 70% by weight of the total weight of the inkjet ink composition.

7. The quick-drying and coating-free inkjet ink composition as claimed in claim 1, wherein the colorant is selected from the group consisting of inorganic pigments, organic pigments, and oil-soluble dyes.

8. The quick-drying and coating-free inkjet ink composition as claimed in claim 1, wherein the resin is selected from the group consisting of polyamide resin, acrylic resin, styrene resin, phenol resin, keto-aldehyde resins, phenolic resin, polyvinyl butyral resin, and polyvinyl pyrrolidone resin, and a solubility of the resin in the solvent is at least 20 wt %, and the molecular weight of the resin is in the range of 5,000 to 100,000, and the glass transition temperature (Tg) of the resin is more than 40° C.

9. The quick-drying and coating-free inkjet ink composition as claimed in claim 1, wherein the plasticizer is selected from the group consisting of phthalate esters, alkyl phenol sulfonic acid esters, adipic acid ester, decanedioic acid esters, castor oils, phosphate esters, and citric acid esters.

10. The quick-drying and coating-free inkjet ink composition as claimed in claim 1, wherein the surfactant is selected from the group consisting of organic silicon compound, and fluorocarbon compound, and the surfactant is anion type, cation type, nonion type, or amphoteric ion type.
